(19) United States
(12) Patent Application Publication
(10) Pub. No.: US 2019/0120459 A1
(43) Pub. Date: Apr. 25, 2019

(54) High Bay Light with Removeable Lens

(71) Applicant: Shenzhen Long Sun Optoelectronics Technology Co., Shenzhen (CN)

(72) Inventor: Zebin Zheng, Shenzhen (CN)

(73) Assignee: Shenzhen Long Sun Optoelectronics Technology Co., Shenzhen, OT (CN)

(21) Appl. No.: 15/952,960

(22) Filed: Apr. 13, 2018

(30) Foreign Application Priority Data
Oct. 24, 2017 (CN) 201721387087.8

(51) Int. Cl. F21V 5/00; F21S 8/06; F21V 21/03; F21V 21/092; F21V 9/14

(52) U.S. Cl. CPC F21V 5/007; F21S 8/061; F21V 9/14; F21V 21/092; F21V 21/03

(57) ABSTRACT

The present invention discloses a high bay light, including a cover plate, an illumination module, a lens module and a mounting mechanism. The lens module is removably mounted to the high bay light, providing convenience and saving costs to users when the floor plans are updated or the purpose of the building is changed wherein the high bay light is installed.

### CROSS REFERENCE TO RELATED APPLICATIONS

The present invention claims the benefit of Chinese Patent Application No. 201721387087.8 entitled the same filed on Oct. 24, 2017, the entire contents of which are incorporated herein by reference.

### TECHNICAL FIELD

The present invention relates to high bay lights. More specifically, the present invention relates to high bay lights with removable lens.

### BACKGROUND OF THE INVENTION

High bay lights are usually used in connection with high ceilings in places such as warehouses, factories and gymnasiums where the ceilings are usually twenty feet or higher. Due to the high ceilings they are mounted on, high bay lights need to cover a lot of spaces both vertically and horizontally. As such, high bay lights generally use light sources with high lumens and lenses that spreads the light to all angles. Although high lumen light sources may be used, the high lumens of the light source bring high heat that needs to be effectively dissipated. High heat is undesirably as it is a fire hazard, shortens the life spans of the lightings and the parts thereof, and increases maintenance costs etc. However, even with high lumen light sources, after being spread over a vast amount of space, the average lumen per area received in the room may still be insufficient.

To address this problem, lighting lenses that directionally spread light to predetermined angles may be used. Using such lenses, the light emitted by the light sources is projected into one or more spot light area where the light can be concentrated, leaving the areas outside of the spot light darker. With current technology, the lighting lenses can cast light into almost all angles that increases freedom in lighting design. With careful lens choice, different lighting effects can be achieved. As such, high bay lighting systems generally pre-mount the high bay light fixtures and place them evenly across the building. When an application is determined and the areas that need to receive higher lumens are identified, appropriate lenses can be chosen to provide the needed light for those areas, leaving other places darker.

However, the floor plans of the building of a preexisting project may change that requires a corresponding change of the high-lighted areas. Moreover, the usage of the building may change as well, such as when it is changed from a warehouse to a big-box store. As such, the lighting plan of the building need to be updated from time to time. In the conventional art, many parts of the high bay lights are fixedly connected to each other. When such change occurs, substantial parts of the high bay lights and sometime the entire fixture have to be replaced, resulting in high costs in parts and labor and economic waste for the owner or user. As such, there is a need for high bay lights with lenses that can be updated without replacing or updating other parts of the light.

### SUMMARY OF THE INVENTION

Among the general objects of the invention is to provide a high bay light with removable lens that can be conveniently updated.

Another object of the present invention is to provide a high bay light, including: a cover plate configured to cover an illumination module and a lens module of said high bay light; the illumination module generating light enclosed in the lens module; the lens module removably attached to the cover plate comprising a plurality of lenses, said plurality of lenses configured to spread the light generated by the illumination module to a predetermined angle; and a mounting mechanism mounting the high bay light to a ceiling, wherein the high bay light has an elongated rectangular bottom shape and a linear side shape.

Another object of the present invention is to provide a high bay light having a cover plate including a flat cover portion and two edges located on either longitudinal side of the flat cover portion, wherein the two edges extend in an angular direction from the flat cover portion, configured to form the linear side shape of the high bay light. The cover plate is a thin plate made of at least one material of an aluminum, iron, alloy, plastics and polycarbonate using at least one manufacturing method of a stamping, die casting, molding injection and computer numeric control machining.

Another object of the present invention is to provide a high bay light with an illumination module further including a plurality of LED beads; and at least one PCB board providing power to the plurality of LED beads, wherein the LED beads are generally evenly distributed on the at least one PCB board.

Another object of the present invention is to provide a high bay light of a plurality of lenses having one of a single polarization and dual polarization, wherein the predetermined angle the light spreads is between a 0 degree and 180 degree. The high bay light has a plurality of strips preventing particles from entering an enclosure between the cover plate the lens module. The high bay light is mounted to the ceiling using one of a hanging mount and a ceiling suction mount.

Another object of the present invention is to provide a high bay light, including: a cover plate having elongated rectangular bottom shape and a linear side shape providing heat dissipation surfaces exposed to ambient air; an illumination module generating light and heat in thermal communication to the cover plate; a lens module removably attached to the cover plate comprising a plurality of lenses, said plurality of lenses configured to spread the light generated by the illumination module to a predetermined angle; and a mounting mechanism mounting the high bay light to a ceiling, wherein the cover plate dissipates heat generated by the illumination module to the ambient air.

Another object of the present invention is to provide a high bay light, including a cover plate of an elongated rectangular bottom shape and a linear side shape configured to cover an illumination module and a lens module of said high bay light; the illumination module generating light enclosed in the lens; the lens module removably attached to the cover plate comprising two lenses, said two lenses configured to spread the light generated by the illumination module to a predetermined angle; two ring shape strips each placed between one of the two lenses and the cover plate, preventing particles from entering enclosures formed between the cover plate and the two lenses; and a mounting mechanism mounting the high bay light to a ceiling, wherein the lenses are fixedly connected to the cover plate and the illumination module using a plurality of bolts and bolt covers.

### BRIEF DESCRIPTION OF FIGURES

The above-mentioned advantages and other features of the present invention will become more apparent to and the invention will be better understood by people of ordinary skill of the art, with reference to the following description of the preferred embodiments of the invention taken in conjunction with the accompanying drawings, wherein:

FIG. 1 is a bottom perspective view of the high bay light according to a preferred embodiment of the present invention.

FIG. 2 is a close-up partial exploded bottom perspective view of the high bay light according to a preferred embodiment of the present invention.

FIG. 3 is a partial close-up bottom perspective view of the cover plate according to an embodiment of the present invention.

FIG. 4 is a side view of the junction box of the high bay light according to a preferred embodiment of the present invention.

FIG. 5 is a side cross-sectional view of the electrical wiring on at the wiring aperture according to a preferred embodiment of the present invention.

### DETAILED DESCRIPTION OF THE INVENTION

One or more embodiments are illustrated by way of example, and not by limitation. In the figures of the accompanying drawings, elements having the same reference numeral designations represent like elements throughout. The drawings are not to scale, unless otherwise noted.

It is to be understood that all terminologies and phraseology used herein are for the purpose of illustrating and should not be understood as limiting. The phrases such as “including”, “comprising”, “having” and other variations thereof are meant to encompass the items as described and their equivalents without excluding any additional items thereof. Terms such as “coupled”, “mounted”, “connected” and other variations thereof are meant to be interpreted broadly to include any coupling, mounting and connection, directly or indirectly with or without intermediate items.

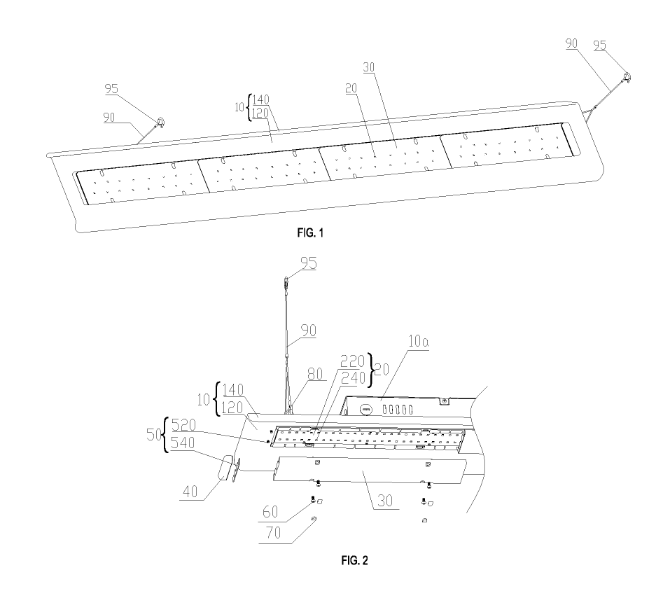

FIG. 1 is a bottom perspective view of the high bay light according to a preferred embodiment of the present invention. FIG. 2 is a close-up partial exploded bottom perspective view of the high bay light according to a preferred embodiment of the present invention. Referring to FIGS. 1-2, the high bay light 1 comprises a cover plate 10, an illumination module 20, and a lens module 30. The illumination module 20 is enclosed in the lens module 30 when attached to the cover plate 10. The cover plate 10 comprises a flat cover portion 120 and two edges 140 located on either side of the flat cover portion 120. The flat cover portion 120 have a substantially rectangular bottom view. According to the preferred embodiment of the present invention, the longitudinal side of the flat cover portion 120 is substantially longer than the width side thereof, creating an elongated visual effect of the bottom view.

The edges 140 extends slightly downward from the side of the flat cover portion 120 they are next to, forming an open housing area on the bottom side for accommodating the illumination module 20 and the lens module 30. When the high bay light 1 is installed, the flat cover portion 120 will be substantially parallel to the floor, whereas the edges 140 will be slightly extending downwards in a sloping manner and tapering the light coming out of the illumination module 30 to a downward direction. According to a preferred embodiment of the present invention, the overall drop of the slope of the edges 140 is configured to be small, creating a linear and elongated visual effect when viewed from the longitudinal side of the high bay light 1. It is understood that the sloping angle of the edges 140 can be varied. For example, the edges 140 may extend inward or having one edge extend inward and the other edge extend outward. While all alternatives are within the scope of the present invention, it is the preferred embodiment of the present invention to have both edges 140 extending downward and outward to maximize the protection provided by the open housing area on the bottom side of the cover plate 10.

On the top side of the high bay light 120, two hanging cables 90 are removably attached thereto from their bottom ends near the short ends of the cover plate 10. At the top ends of the hanging cables 90, two buckles 95 are attached therewith, configured to buckle onto the ceiling system of the building where the high bay light 1 is installed.

The open housing area accommodates and protects the illumination module 20 and the lens module 30 located therein. Both lens module 30 and illumination module 20 are of elongated and flat shape, with the illumination module 20 being located inside of the lens module 30. They are closely attached to the middle of the bottom side of the flat cover portion 120, with offsets from all sides of the perimeter of cover plate 10.

The light source of the illumination module 20 can be one of an LED lighting, a fluorescent lighting, an incandescent lighting or other known lightings. According to the preferred embodiment of the present invention, the light source of the illuminating block 20 is an LED lighting. Referring to FIG. 2, the illuminating block 20 comprises a PCB board 220 and a plurality of LED beads 240 distributed across one side of the PCB board 220. The type and number of the LED beads 240, as well as the space between them are configurable during manufacturing using known art to adjust the total lumen and the heat dissipation of the illumination, thereby providing flexibility to offer flexible specifications suitable for various application requirements. According to a preferred embodiment of the present invention, the LED beads 220 are evenly distributed in an array along the longitudinal side of the PCB board 220.

The PCB board 220 has two sides. The LED beads 240 are located on the bottom side and emit lights to the room below the high bay light 1. On the top side (not seen), the circuitry on the PCB board 220 provide the electrical power to the LED beads 240 it receives from the driver of the high bay light 1. The PCB board 220 is also in thermal communication with the cover plate 10 and are in thermal communication thereof via a surface-to-surface contact the cover plate 10. As described herein and elsewhere, cover plate 10 is preferably a thin plate with a bottom shape of an elongated rectangle, of which a substantial surface area on the bot and bottom side is in direct contact with ambient air to facilitate heat dissipation.

The lens module 30 covers the illumination module 20. Preferably, the lens module 30 is a refraction lens or other known type of lens that may refract light to a pre-determined angle. The lens module 30 may be a refraction and/or reflection lens or lens in combination thereof, which may be configured to distribute the light from the illumination module 20 to single or dual polarization of any degrees, such as 20 degrees, 30 degrees, 45 degrees, 60 degrees, 90 degrees and 120 degrees. The lens module 30 may comprise a single lens or a plurality of lenses. The lens module 30 is removably attached to the cover plate 10, wherein the connection may be made by one of a bolt connection, a snapped-on connection, a plugged-in connection, or any other connections that are known to people of ordinary skill of the art. As such, the lighting effect of the building with pre-installed high bay lights of the present invention can be very easily management. For example, in case when the building's floor plan is updated, or the building's function is changed, which make it necessary to change the lighting distribution or the focal points thereof, instead of changing the light fixtures, the building owner need only to order and replace the lens module 30 of the high bay light 1. It saves a lot of cost in building maintenance and updates.

According to an embodiment of the present invention, the high bay light 1 further comprise end caps 40. The end caps 40 are configured to be removably attached to the cover plate 10. The end caps 40 are also configured to match the shape of the short ends of lens module 30, removably attached therewith, providing closure to the open width side of the lens module 30. The end caps 40 can be bade of aluminum, iron, brass, plastics or other materials preferably with good heat dissipating performance. Alternatively, the terminal ends of the lens module 30 may be configured to be in contact with the cover plate 10, thus eliminating the need for the end caps 40 and the strips 50 as described elsewhere.

The high bay light 1 further comprises strips 50. The shape of the strip 50 can be circular, ring or any other shapes that may effectively keeping dust and moisture out of the enclosure of the lens module 30. Preferably, the strips 50 are made of silicon and other materials of good sealing performance. According to a preferred embodiment of the present invention, the strips 50 comprises side strips 520 and end strips 540. More specifically, side strips 520 are placed on the longitudinal sides between the lens module 30 and the cover plate 10. The second strips 540 are placed between the lens module 30 and the end caps 40. When used together, the strips 50 form a continuous loop on the perimeter of the lens module 30 to prevent particles from getting into the enclosure between the cover plate 10 and the lens module 30, such as dust and moisture, protecting the cleanness of the enclosure and high quality of light coming out of the les module 30.

According to another preferred embodiment of the invention, for example when the lens module comprises two lenses, the strips 50 may comprise two rings shaped strips (not shown), each placed in the inside groove of the lens, forming two continuous loop each corresponding to a lens. The two ring shaped strips seals off gaps between the lenses and the cover plate 10 and prevent dust and moisture from coming inside of the lenses.

The high bay light 1 further comprises bolts 60 and bolt covers 70. Referring to FIG. 2, the lens module 30 comprises inside grooves (not shown) and apertures (not shown) configured to allow bolts 60 to fasten lens module 30 to the body of the cover plate 10. The bolt covers 70 are placed into the apertures to hide the bolts 60 from sight, enhancing the high bay light 1's aesthetics appeal.

To mount the high bay light 1 to the ceiling system of the building, a variety of mounting mechanism may be used, including hanging, ceiling suction and other mechanisms. FIG. 2 illustrates a hanging mechanism according to an embodiment of the present invention. Referring to FIG. 2, the high bay light 1 further comprises buckles 80, hanging cables 90 and buckles 95. The hanging cables 90 are configured to hang the high bay light 1 to the ceiling system of the building where the high bay light 1 is installed. The buckles 80 are attached to the top side of the cover plate 10, which is the side opposite to where the illumination module 20 and the lens module 30 are located. The hanging cables 90 are attached to the buckles 80 and 95, either fixedly or removably, on either ends of the hanging cables 70. The removable attachment between the hanging cables 90 the buckles provides a system for convenient maintenance of the high bay light 1. According to an embodiment of the present invention, the hanging cables are electrical wirings that provide dual functions of hanging and wiring at the same time, thereby saving costs for the lighting application. According to another embodiment of the present invention, the mounting mechanism a suction ceiling mount (not shown). The suction ceiling mount include first brackets, second brackets and a ceiling suction part, wherein the first brackets and second brackets are attached to the high bay light 1 and the ceiling suction part is pre-mounted to the ceiling. When mounting the high bay light 1, the first brackets and the second brackets are first loosely hung to the pre-mounted ceiling suction part before fastened them to the ceiling suction part with screws to lock the high bay light 1 therein.

Cover plate 10 is the major part for heat dissipation according to the present invention. As described above, cover plate 10 is of an elongated rectangular bottom shape extending in the mid-air with substantial surface area exposed to the air. The cover plate is also very thin, thereby reducing the heat accumulation in the cover plate 10 and quickly dissipate the heat to the ambient air. The cover plate 10 may be manufactured using one of a stamping, die casting, molding injection, CNC (computer numeric control) machining, or other manufacturing processes known in the art.

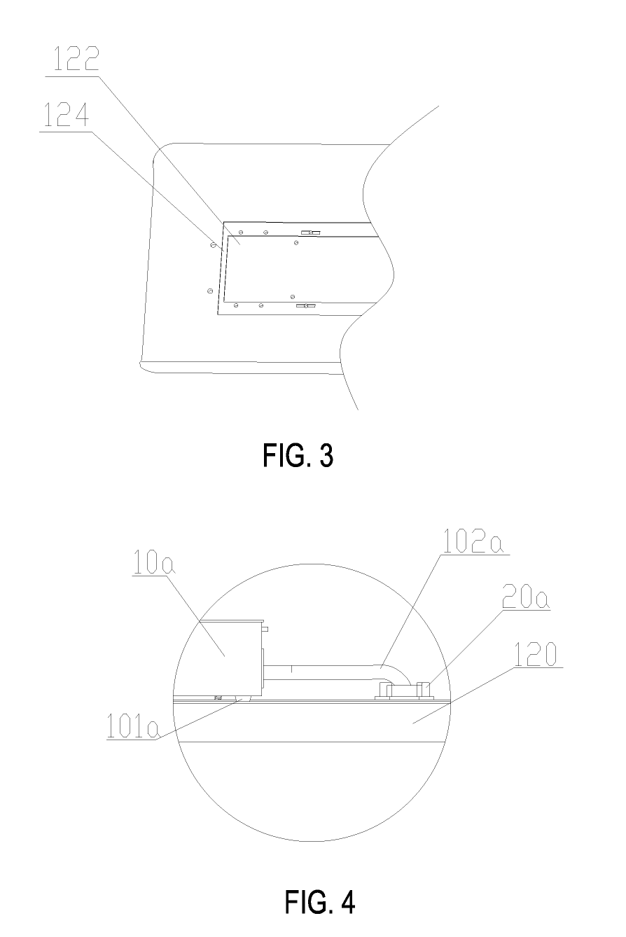

FIG. 3 is a partial close-up bottom perspective view of the cover plate 10 according to an embodiment of the present invention. Referring to FIG. 3, the cover plate 10 comprises a first positioning groove 122 and a second positioning groove 124. According to a preferred embodiment of the present invention, the cover plate 10 is made using a stamping process, wherein the second positioning groove 124 is stamped on the bottom side of the cover plate 10 and the first positioning groove 122 is stamped on top of the second positioning groove 124. The first positioning groove 122 is configured to match the shape of the illumination module 20 and lock the illumination module 20 in place, preventing it from moving sideways. The second positioning groove 124 is configured to match the shape of the lens module 30 and lock the lens module 124 in place, preventing it from moving sideways. The matching cover of the lens module 30 is located on the illuminating block 20. The first positioning groove 122 and the second positioning groove 124 keep particles such as dust and moisture out of the enclosure of the lens module 30. According to another embodiment of the present invention, when the lens module 30 comprises 2 lenses, the lenses may be configured to be in close contact with the bottom side of the cover plate 10 as described herein and elsewhere. As much, the positioning grooves 122 and 124 maybe eliminated from the cover plate 10, simplifying the stamping process.

Cover plate 10 can be made of aluminum, iron, other metals or alloys, plastics, polycarbonate (“PC”) or other materials. According to a preferred embodiment of the present invention, the cover plate 10 is made of aluminum because of aluminum's advantages in heat dissipation and its lightweight. According to another preferred embodiment, the cover plate 10 is made of PC.

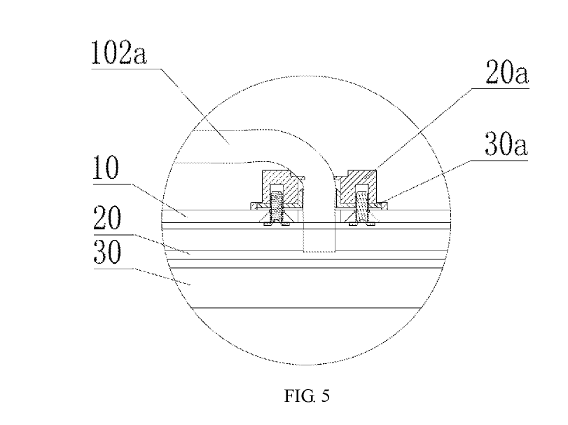

FIG. 4 is a side view of the junction box of the high bay light according to a preferred embodiment of the present invention. Referring to FIGS. 2 and 4, the high bay light 1 further comprises a junction box 10a, housing the driver of the high bay light 1 and the wiring thereof. The junction box 10a comprises stands 101a, which raise the junction box up and leaves a gap between the bottom of the junction box and the flat cover portion 120. The gap between the junction box 10a and the flat cover portion 120 of the cover plate 10. This gap allows air to go through, facilitating heat dissipation of the high bay light 1. A power cable 102a electrically communicative with the illumination module 20 comes out of the side of the junction box 10a and goes to the bottom side of cover plate 10 where the illumination module is located through a wiring aperture (not shown) located on the cover plate 10. The electrical wiring of the cable 102a will be described in more details in FIG. 5. The power source contained in the junction box 10a can be directly derived from the alternating-current (AC) power of the building, low voltage power transformed from the AC power, or constant current power provided by the constant power devices, determined by the type of the light source the high bay light requires. Alternatively, the light source of the high bay light 1 may be integrated into integrated circuit. As such the junction box 10a may be eliminated all together.

FIG. 5 is a side cross-sectional view of the electrical wiring on at the wiring aperture according to a preferred embodiment of the present invention. Referring to FIGS. 4-5, the fastening apparatus at the wiring aperture comprises pull-resistant terminal 20a and dust pad 30a. The power cable 102a connecting the power from the junction box 10a to the illumination block 20 goes through the wiring aperture configured to let the power cable 102 go between the pull-resistant terminal 20a and into the aperture located on cover plate 10. The pull-resistant terminal 20a is connected to the cover plate 10 fastened by screws. Near the top of the pull-resistant terminal 20a, a small extrusion thereon extends inwardly towards the wiring terminal, configured to clamp onto the outside of the wiring cable 102a thereby proving a pull-resistance mechanism. Dust pad 30a is located underneath the pull-resistant terminal in contact with the cover pate 10, preventing dust or moisture from getting underneath the cover plate 10. According to a preferred embodiment of the present invention, when the lens illumination module comprises two LED modules, the electrical wiring of the two LED modules may be connected in series underneath the cover plate 10, with one wiring cable providing power to both modules illustrated herein.

Alternatively, the two LED modules may be connected to each other via a wire running on the top side of the cover plate 10 after said wire coming out of either LED modules goes through a separate aperture on the cover plate 10. According to this embodiment, said wire is attached to the top side of the cover plate 10, placed under a water-proof cover to prevent particles such as dust and moisture from going inside of the high bay light 1. The water-proof cover may be made of die-cast aluminum or injection molding.

It is apparent to the people of ordinary skilled in the art that the present invention provides the advantage of allowing users to conveniently change and replace the lenses of the high bay light, with lenses of different illuminating angles. Depending on the requirements of the different applications, user can easily choose and change the lighting angle. Users can choose to illuminate objects in one area using lenses matching the required lighting angle and change the removably attached lenses to other angles when the requirements change, without having to replace the lightings, saving cost for the users.

The above descriptions of the embodiments of the present disclosure are provided for demonstration to persons skilled in the art, instead of exhaustively listing all the embodiments or limiting the present disclosure to a single disclosed embodiment. In view of the above, various replacements and variations to the present disclosure are apparent to persons skilled in the art. Therefore, although some alternative embodiments have been discussed in detail, other embodiments are apparent or can be readily derived by a person skilled in the art. The present disclosure is intended to cover all the replacements, modifications and variations to the present disclosure that have been discussed here as well as other embodiments consistent with the spirit and scope of the present disclosure.

What is claimed is:

1. A high bay light, comprising:
a cover plate configured to cover an illumination module and a lens module of said high bay light;
the illumination module generating light enclosed in the lens module;
the lens module removably attached to the cover plate comprising a plurality of lenses, said plurality of lenses configured to spread the light generated by the illumination module to a predetermined angle; and
a mounting mechanism mounting the high bay light to a ceiling,
wherein the high bay light has an elongated rectangular bottom shape and a linear side shape.

2. The high bay light of claim 1, wherein the cover plate further comprising:
a flat cover portion; and
two edges located on either longitudinal side of the flat cover portion,
wherein the two edges extend in an angular direction from the flat cover portion, configured to form the linear side shape of the high bay light.

3. The high bay light of claim 1, wherein the cover plate is a thin plate made of at least one material of an aluminum, iron, alloy, plastics and polycarbonate using at least one manufacturing method of a stamping, die casting, molding injection and computer numeric control machining.

4. The high bay light of claim 1, wherein the illumination module further comprising:
a plurality of LED beads; and
at least one PCB board providing power to the plurality of LED beads,
wherein the LED beads are generally evenly distributed on the at least one PCB board.

5. The high bay light of claim 1, wherein the plurality of lenses have one of a single polarization and dual polarization, and wherein the predetermined angle the light spreads is between a 0 degree and 180 degree.

6. The high bay light of claim 1, further comprising a plurality of strips preventing particles from entering an enclosure between the cover plate the lens module.

7. The high bay light of claim 1, wherein the mounting mechanism is one of a hanging mount and a ceiling suction mount.

8. The high bay light of claim 1, further comprising:
a junction box;
at least one wiring cable in electrical communication with the junction box,
wherein the at least one wiring cable is connected to the illumination module via an aperture on the cover plate.

9. The high bay light of claim 1, wherein the cover plate is in thermal communication with the illumination module and the lens module.

10. A high bay light, comprising:
a cover plate having elongated rectangular bottom shape and a linear side shape providing heat dissipation surfaces exposed to ambient air;
an illumination module generating light and heat in thermal communication to the cover plate;
a lens module removably attached to the cover plate comprising a plurality of lenses, said plurality of lenses configured to spread the light generated by the illumination module to a predetermined angle; and
a mounting mechanism mounting the high bay light to a ceiling,
wherein the cover plate dissipates heat generated by the illumination module to the ambient air.

11. The high bay light of claim 10, wherein the cover plate further comprising:
a flat cover portion; and
two edges located on either longitudinal side of the flat cover portion,
wherein the float cover portion is in thermal communication with the illumination module, and wherein the two edges extend in an angular direction from the flat cover portion, configured to further dissipate the heat received from the flat cover portion.

12. The high bay light of claim 10, wherein the cover plate is a thin plate made of at least one material of an aluminum, iron, alloy, plastics and polycarbonate using at least one manufacturing method of a stamping, die casting, molding injection and computer numeric control machining.

13. The high bay light of claim 10, wherein the illumination module further comprising:
a plurality of LED beads substantially evenly distributed on at least one PCB board; and
the at least one PCB board providing power to the plurality of LED beads and is in a surface thermal communication with the cover plate,
wherein the at least one PCB board dissipates heat generated by the plurality of LED beads to the cover plate.

14. The high bay light of claim 10, wherein the plurality of lenses have one of a single polarization and dual polarization, and wherein the predetermined angle the light spreads is between a 0 degree and 180 degree.

15. The high bay light of claim 10, further comprising a plurality of strips preventing particles from entering an enclosure between the cover plate the lens module.

16. The high bay light of claim 10, wherein the mounting mechanism is one of a hanging mount and a ceiling suction mount.

17. The high bay light of claim 10, further comprising:
a junction box;
at least one wiring cable in electrical communication with the junction box,
wherein the at least one wiring cable is connected to the illumination module via an aperture on the cover plate.

18. The high bay light of claim 17, wherein the junction box is placed on a stand configured on the cover plate providing a heat dissipating gap between the junction box and the cover plate.

19. A high bay light, comprising:
a cover plate of an elongated rectangular bottom shape and a linear side shape configured to cover an illumination module and a lens module of said high bay light;
the illumination module generating light enclosed in the lens;
the lens module removably attached to the cover plate comprising two lenses, said two lenses configured to spread the light generated by the illumination module to a predetermined angle;
two ring shape strips each placed between one of the two lenses and the cover plate, preventing particles from entering enclosures formed between the cover plate and the two lenses; and
a mounting mechanism mounting the high bay light to a ceiling,
wherein the lenses are fixedly connected to the cover plate and the illumination module using a plurality of bolts and bolt covers.

20. The high bay light of claim 19, wherein the two lenses have one of a single polarization and dual polarization, and wherein the predetermined angle the light spreads is between a 0 degree and 180 degree.
